(19) United States
(12) Patent Application Publication
(10) Pub. No.: US 2016/0097233 A1
(43) Pub. Date: Apr. 7, 2016

(54) Door Frame Member and Garage Door Kit

(71) Applicant: T & T Custom Wood Products Inc., London (CA)

(72) Inventor: Trevor Thomas Esler, London (CA)

(21) Appl. No.: 14/871,309

(22) Filed: Sep. 30, 2015

Related U.S. Application Data
(60) Provisional application No. 62/058,182, filed on Oct. 1, 2014.

(30) Foreign Application Priority Data
Apr. 1, 2015 (CA) 2887176

(51) Int. Cl. E06B 1/30; E06B 1/52

(52) U.S. Cl. CPC E06B 1/30; E06B 1/522

(57) ABSTRACT

A door frame member made from Celuka PVC is provided for use as the jambs and upper transverse member of a garage door frame. The door frame member has a first structural element and a second decorative facing element which are attached by means of fusion welding.

### FIELD OF THE INVENTION

The present invention relates to door frame members, in particular, garage door frames made from durable cellular polyvinyl chloride (PVC).

### BACKGROUND

Traditional garage door frames are made from wood. The wood material has several disadvantages, including susceptibility to rotting, high upkeep, such as a requirement for regular re-painting, and difficulty in obtaining high quality lumber.

Garage door frames made from standard, or free foam, PVC materials are sometimes used in place of the traditional wooden garage door frames. However, free foam PVC frames are softer, damage easily, and expose air pockets when cut.

The present application relates to a door frame member for a garage door frame, made from a durable cellular PVC material, known as Celuka PVC, as described below.

### SUMMARY OF THE INVENTION

According to one aspect of the present invention, a door frame member is provided made from a Celuka PVC material. The door frame member is comprised of a first structural element and a second decorative facing element. The first structural element is attached to the second decorative facing element by means of fusion welding.

In another embodiment of the door frame member according to the present invention, the second decorative facing element further has an attachment flange along the length thereof.

In another embodiment of the door frame member according to the present invention, the door frame member further comprises an intermediate spacing element. The first structural element is attached to one end of the spacing element and the second decorative facing element is attached to the opposing end of the spacing element.

In another embodiment of the door frame member according to the present invention, the door frame member is curved.

According to another aspect of the present invention, a door frame kit is provided, comprising three door frame members cut to specification for use as the jambs and upper transverse member of a door frame.

### BRIEF DESCRIPTION OF THE DRAWINGS

In order that the invention may be more clearly understood, preferred embodiments thereof will now be described in detail, by way of example, with reference to the accompanying drawings, in which:

FIG. 1 is a perspective view of a garage door frame constructed with door frame members according to the present invention.

FIG. 2 is a front view of the garage door frame shown in FIG. 1.

FIG. 3A is a side view of the garage door frame shown in FIG. 1.

FIG. 3B is a side view of the garage door frame shown in FIG. 1, with an intermediate spacing element in the door frame members.

FIG. 4 is a cross-sectional view of the door frame member, according to the present invention.

FIG. 5 is a cross-sectional view of another embodiment of the door frame member, including an intermediate spacing element.

FIG. 6 is a perspective view of a garage door frame constructed with door frame members according to the present invention, including a curved door frame member.

FIG. 7 is a front view of the garage door frame shown in FIG. 6.

FIG. 8A is a side view of the garage door frame shown in FIG. 6.

FIG. 8B is a side view of the garage door frame shown in FIG. 6, with an intermediate spacing element in the door frame members.

### DESCRIPTION OF THE INVENTION

The term “Celuka PVC”, as used herein, refers to foamed polyvinyl chloride material with a hard outer surface made according to the Celuka extrusion process. The Celuka extrusion process for PVC involves extruding a PVC melt containing chemical blowing agents through a hollow die. As the extrudate exits the die, the outer surface of the extrudate is immediately cooled. This cooling suppresses cell formation at the surface of the extrudate, resulting in a hard, durable finish. The subsurface extrudate remains hot and expands inwardly to fill the profile shape of the die. The Celuka process results in a lightweight cellular PVC extrusion with a hard, durable outer shell.

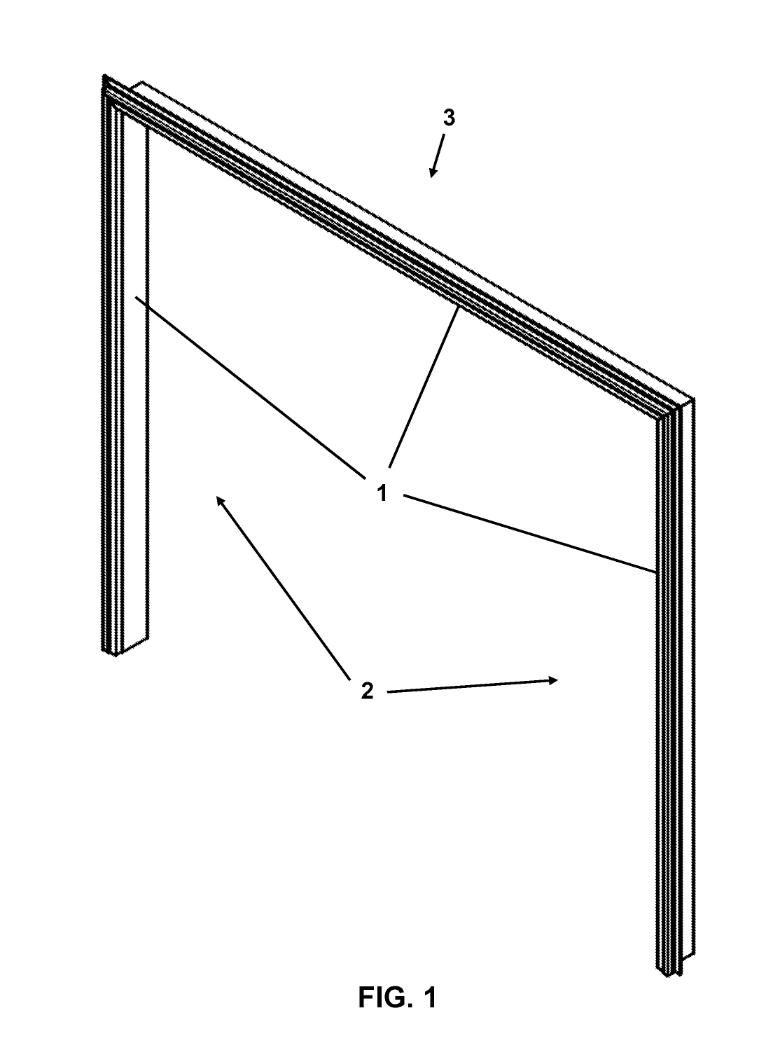

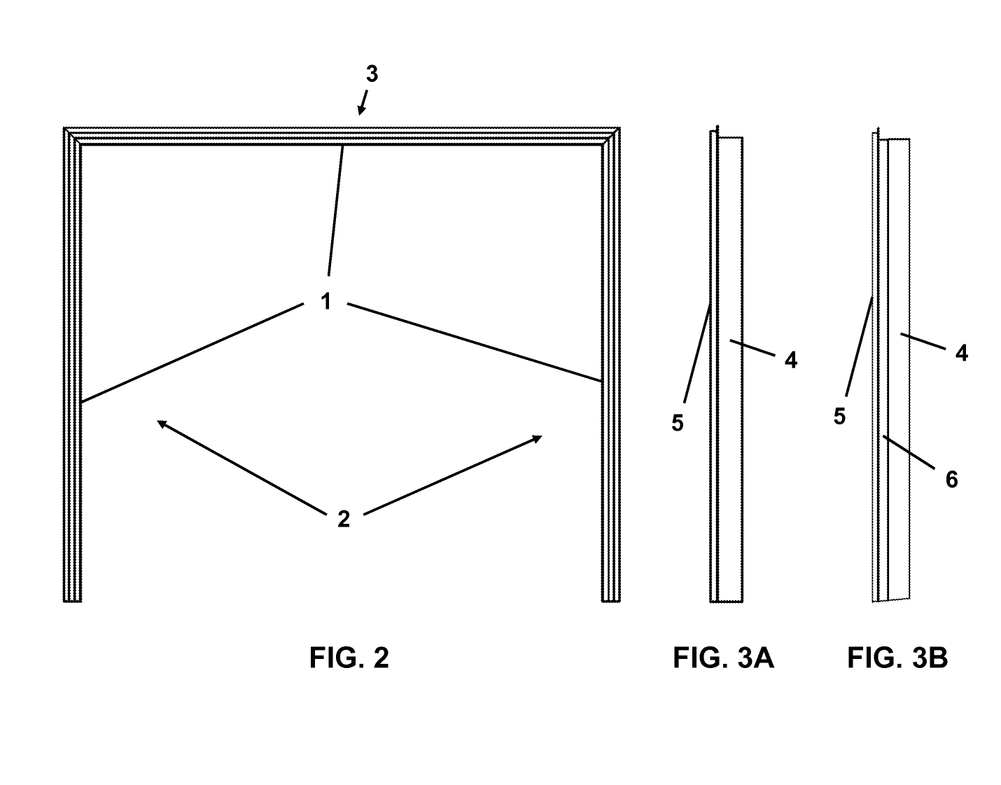

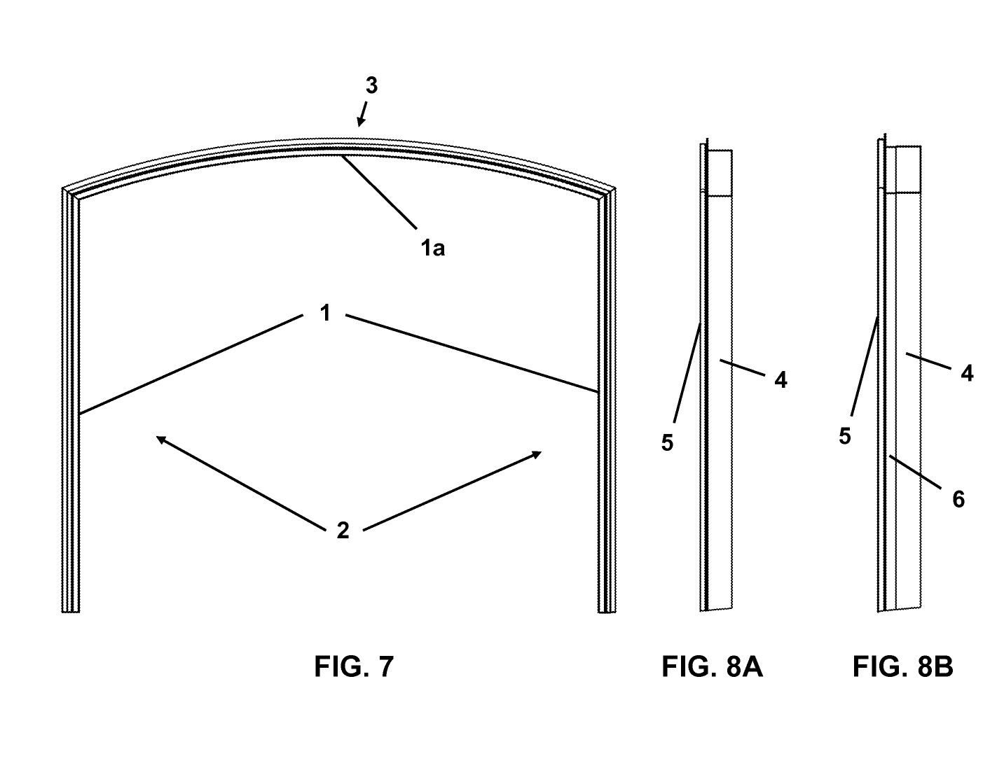

A door frame member according to the present invention is proposed. The frame members 1 are preferably used as the jambs 2 and upper transverse member 3 of a garage door frame, as shown in FIGS. 1-3 and 6-8. The frame member 1 is made of Celuka PVC material, such as, for example, KOMACEL™ rigid PVC, available from Kommerling USA, Inc. The use of the Celuka PVC material offers the following desirable features: high durability, longevity, and resilient appearance, which are not presently available using wood or other PVC materials. Preferably, the Celuka PVC material has an Izod impact resistance of 2.0-3.0 ft-lb/in (measured according to the ASTM-D256 standard test method), more preferably 2.5 ft-lb/in, and a density of 40-46 lb/ft³ (measured according to the ASTM-D792 standard test method), more preferably 42 lb/ft³.

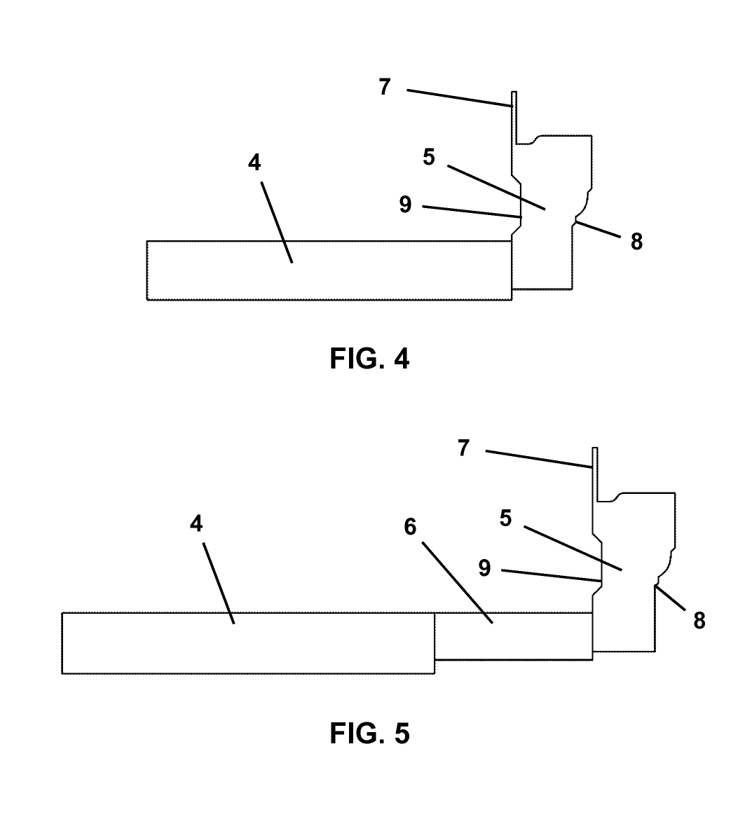

As shown in FIG. 4, the frame member 1 has a first structural element 4, a second decorative facing element 5, as shown in FIG. 4, and, optionally, spacing elements 6, as shown in FIG. 5. The first structural element 4 has a rectangular cross section and a length, preferably with a thickness of about 1″.

The second decorative facing element 5 has a generally square-like or rectangular cross section and a length. The second decorative facing element 5 may have an attachment flange 7 extending from one end of its cross section and along the length thereof, which fits between the supporting structure of the garage door and the bricks of the building. The attachment flange 7 may be provided with apertures, for receiving fasteners to secure the frame member 1 to the supporting structure of the garage door. The decorative surface 8 of the second decorative facing element 5 may be shaped or otherwise ornamented to achieve the desired design aesthetic.

As shown in FIG. 4, a first structural element 4 is attached at one end to a second decorative facing element 5. Preferably, the point of attachment on the second decorative facing element 5 is on the rear surface 9, opposite the decorative surface 8, near or at the end of the second decorative facing element 5 opposite the attachment flange 7. Optionally, the first structural element 4 is attached to one end of an intermediate spacing element 6 and the second decorative facing element 5 is attached to the opposite end of the spacing element 6, as shown in FIG. 5. The spacing element 6 has a rectangular cross section and a length, and is preferably narrower than the first structural element 4. Preferably, the attachment between the first structural element 4, the second decorative facing element 5, and, optionally, the spacing element 6 is by way of fusion welding, using a PVC cement, such as, for example, OATEY™ Medium Clear PVC Cement.

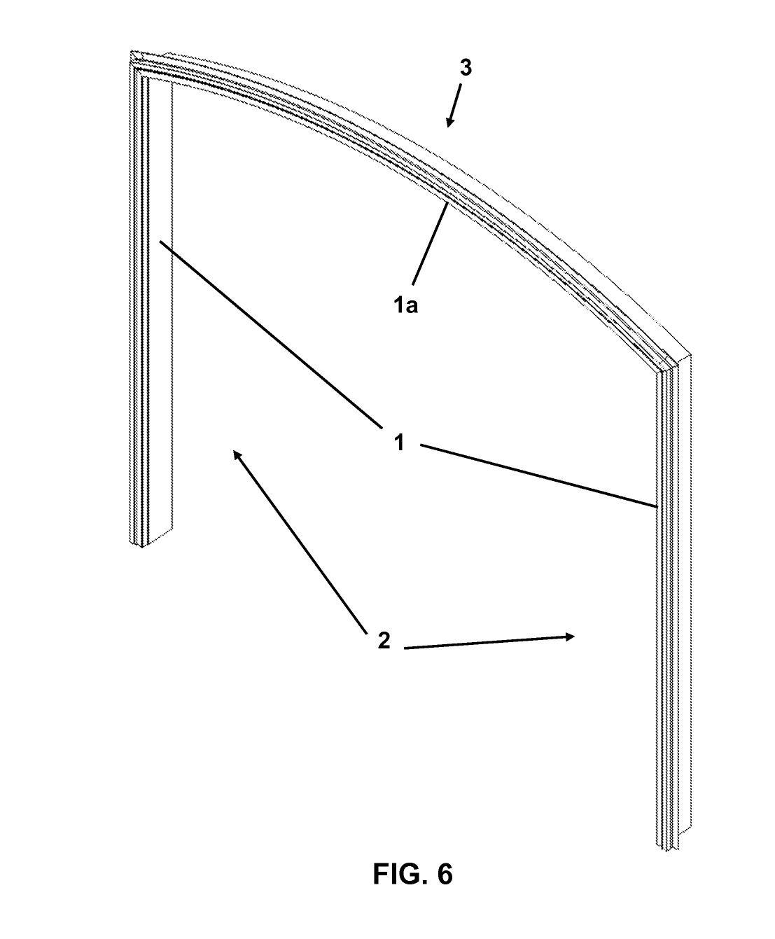

As shown in FIGS. 1-3, the frame members 1 are used as the jambs 2 and the upper transverse member 3 of a garage door frame. The frame 1 may be made to fit any size of garage door, for example, the typical garage door is generally rectangular and measures about 9′ by 8′. Alternatively, as shown in FIGS. 6-8, some or all of the frame members 1 may be curved, for example, in the shape of an arch, by using a curved frame member 1a as the upper transverse member 3 of the garage door frame. Preferably, the curved frame member 1a is curved with a constant arc and has a radius of curvature of about 144″, but the curvature of the curved frame member 1a can be selected to fit any shape of garage door. Preferably, the jambs 2 and upper transverse member 3 are each made of a single length of frame member 1, but each may be made of a plurality of shorter lengths of frame members 1, joined end to end.

One end of each frame member 1 used as a jamb 2 is cut at an angle θ₁. Both ends of each frame member 1 used as an upper transverse member 3 are cut at an angle θ₂. Preferably, angle θ₁ is complementary to angle θ₂, so that when the cut ends of the frame members 1 are abutted, the upper transverse member 3 is disposed at a 90° angle to the jambs 2. Preferably, angle θ₁ and angle θ₂ are chosen so that the cut edges of each frame member 1 are the same length, for example, angle θ₁ and angle θ₂ may both be 45°. The relationship between angle θ₁ and angle θ₂ may also be expressed by the following equation:

θ₁+θ₂=90°

In another embodiment of the present invention, when one or more frame members 1 are curved, the angle θ₁ is complementary to the angle θ₂, so that when the cut ends of frame members 1 and one or more curved frame members 1a are abutted, the frame is complementary to the curved shape of the garage door. Preferably, where the garage door frame is arch shaped, the ends of the upper transverse member 3 are disposed along a line at a 90° angle to the jambs 2. In this embodiment, angle θ₁ and angle θ₂ depend on the distance between the jambs 2 and the radius of curvature of the curved frame member 1a used as the upper transverse member 3. Preferably, angle θ₁ and angle θ₂ are chosen so that the cut edges of each frame member 1 and curved frame member 1a are the same length. The relationship between angle θ₁ and θ₂ can also be expressed by the following equation:

θ₁+θ₂=180°−A°

where: A°=arccos(L_{He}/2 r);
L_{HE} is the distance between the ends of the curved horizontal element; and
r is the radius of curvature of the curved horizontal element.

According to another aspect of the present invention, a method is provided to manufacture a garage door frame. First, a plurality of first structural elements 4, made of a Celuka PVC material, are fusion welded to a plurality of second decorative facing elements 5, made of a Celuka PVC material, thereby creating a plurality of frame members 1. One end of two frame members 1 is cut at an angle θ₁, as described above, for use as the jambs 2. Next, both ends of a frame member 1 are cut at an angle θ₂, as described above, for use as an upper transverse member 3. Three frame members 1, two for use as jambs 2 and one for use as the upper transverse member 3, complete a garage door frame. The jambs 2 and upper transverse member 3 may then be installed within the support structure surrounding a garage. Preferably, fasteners are driven through apertures in the attachment flange 7 and into the support structure to secure the frame members 1 in place.

The jambs 2 and an upper transverse member 3 may also be made using frame members 1 that include an intermediate spacing element 6. In this embodiment, the frame members 1 are created by fusion welding a first structural element 4 to one end of a spacing element 6 and fusion welding a second decorative facing element 5 to the opposing end of the spacing element 6, as described above.

In order to create a curved frame member 1a, the method further comprises the steps of heating a frame member 1 to soften it, bending the frame member 1 into a curved shape, and cooling the frame member 1 to solidify it in its curved shape. Preferably, the frame member 1 is heated, in an oven, for 40-60 minutes, at a temperature of between 130° C. and 180° C. to soften it, so as to allow it to bend. The heated frame member 1 is then bent over a form of the desired shape and held in place while it cools to produce a curved frame member 1a. Preferably, the form has a constant arc with a radius of curvature of 144″, but other shapes and radii are possible. In this embodiment the angle θ₁ and the angle θ₂ are determined, as described for the corresponding embodiment of the frame member 1, above. The ends of the curved frame member 1a are then cut, for example, to create a curved upper transverse member 3 for an arch shaped garage door frame.

According to another aspect of the present invention, a door frame kit is provided with frame members made of Celuka PVC material. The kit has three frame members 1, two for use as the jambs 2 and one for use as the upper transverse member 3, as described above. The kit can then be assembled and installed in the garage door.

A number of embodiments of the present invention have been described. Nevertheless, the scope of the claims should not be limited by the preferred embodiments set out herein, but should be given the broadest interpretation consistent with the specification as a whole.

What is claimed is:

1. A door frame member for a door frame consisting of jambs and an upper transverse member, said door frame member consisting of:
a first structural element having a rectangular cross section and a length; and
a second decorative facing element having a second cross section and a length; wherein
the first structural element is attached to the second decorative facing element by means of fusion welding; and
the door frame member is made of a celuka polyvinyl chloride material.

2. The door frame member of claim 1, wherein the second decorative facing element has an attachment flange along the length thereof.

3. The door frame member of claim 1, wherein the door frame member further comprises an intermediate spacing element and wherein the first structural element is attached to one end of the spacing element and the second decorative facing element is attached to the opposing end of the spacing element.

4. The door frame member of claim 1, wherein the door frame member is curved.

5. A door frame kit, comprising three door frame members, wherein said door frame members consist of: a first structural element having a rectangular cross section and a length and a second decorative facing element having a second cross section and a length, wherein the first structural element is attached to the second decorative facing element by means of fusion welding and the door frame members are made of a celuka polyvinyl chloride material; wherein
the three door frame members are cut to specification for use as the jambs and upper transverse member of a door frame.

6. The door frame kit of claim 5, wherein the second decorative facing element has an attachment flange along the length thereof.

7. The door frame kit of claim 5, wherein the door frame members further comprise an intermediate spacing element and wherein the first structural element is attached to one end of the spacing element and the second decorative facing element is attached to the opposing end of the spacing element.

8. The door frame kit of claim 5, wherein one or more the door frame members are curved.
